(19) United States
(12) Patent Application Publication
(10) Pub. No.: US 2019/0264812 A1
(43) Pub. Date: Aug. 29, 2019

(54) SEALING DEVICE

(71) Applicant: Sanwa Koki Kabushiki Kaisha, Nara (JP)

(72) Inventor: Keiichi OOTANI, Nara (JP)

(73) Assignee: Sanwa Koki Kabushiki Kaisha, Nara (JP)

(21) Appl. No.: 16/219,776

(22) Filed: Dec. 13, 2018

(30) Foreign Application Priority Data
Feb. 28, 2018 (JP) 2018-34851

(51) Int. Cl. F16J 15/14; F16J 15/02; F16J 15/10

(52) U.S. Cl. CPC F16J 15/14; F16J 15/40; F16J 15/102; F16J 15/022

(57) ABSTRACT

A sealing device seals between a rotating shaft inserted into a container and the container. The sealing device includes a housing positioned around the rotating shaft and fixed to the container, a filler filled between the housing and the rotating shaft, and a holding mechanism part securing the filler positioned between the housing and the rotating shaft. The holding mechanism part includes a storing chamber in which the filler is stored in a housing side with respect to the rotating shaft, and a driving part which projects to the storing chamber fixed to the rotating shaft and is driven to flow the filler.

### CROSS-REFERENCE TO RELATED APPLICATIONS

The present application claims priority under 35 U.S.C. 119 to Japanese Patent Application No. 2018-34851, filed on Feb. 28, 2018. The contents of this application are incorporated herein by reference in their entirety.

### BACKGROUND OF THE INVENTION

### Field of the Invention

The present invention relates to a sealing device which easily enhances sealability and durability between a rotating shaft inserted into a container and the container.

### Description of the Related Art

As a conventional sealing device, one employing a mechanical seal (see e.g., Japanese Patent Application Publication No. 2013-177914), or one employing a gland packing (see e.g., Japanese Patent Application Publication No. 2018-9671) have been proposed.

The technology described in Japanese Patent Application Publication No. 2013-177914, which employs the mechanical seal, includes a structure in which a rotary side seal surface of a rotary sealing ring installed in the rotary side (shaft side) and a static side sealing surface of a static sealing ring installed in the static side (case (container) side) are brought into slide contact with each other (see paragraph [0020] of Japanese Patent Application Publication No. 2013-177914).

The rotary side seal surface of the rotary sealing ring is brought into slide contact with the static side sealing surface of the static sealing ring in a pressing manner in a predetermined pressure (see paragraph [0026] of Japanese Patent Application Publication No. 2013-177914).

In Japanese Patent Application Publication No. 2018-9671 describing the technology related to a gland packing, it discloses to provide the gland packing which demonstrates a sliding characteristic, a durability, and a seal performance.

The gland packing is applied for sealing a gland part of a shaft such as a rotating shaft, a reciprocating mechanism, etc. When the shaft is operated, the contact part of the gland packing is brought into slide contact with the shaft. It discloses the necessity of maintaining lubricity of the contact face (see paragraph [0002] of Japanese Patent Application Publication No. 2018-9671).

Further, in the gland packing applying for a use of a rotary pump, a seal performance, handleability, an abrasion resistance, etc. are required as a countermeasure against leakage (see paragraph [0003] of Japanese Patent Application Publication No. 2018-9671).

In the conventional mechanical seal, there has been an issue in an abrasion resistance due to the friction between a rotary ring, which rotates with a rotating shaft, and a fixing ring. Further, in the conventional sealing device applying the gland packing, there has been an issue in an abrasion resistance due to the pressurized state between the gland packing and the shaft.

That is, in the conventional sealing device, a sliding part exists, so that there have been issues in the abrasion resistance and the sealability due to the abrasion resistance. Therefore, it is desired to further improve durability.

The description herein of advantages and disadvantages of various features, embodiments, methods, and apparatus disclosed in other publications is in no way intended to limit the present invention. For example, certain features of the preferred described embodiments of the invention may be capable of overcoming certain disadvantages and/or providing certain advantages, such as, e.g., disadvantages and/or advantages discussed herein, while retaining some or all of the features, embodiments, methods, and apparatus disclosed therein.

### SUMMARY OF THE INVENTION

The disclosed embodiments of the present invention have been developed in view of the above-mentioned and/or other problems in the related art. The disclosed embodiments of the present invention can significantly improve upon existing methods and/or apparatuses.

The present invention was created considering the aforementioned conventional status. An object is to provide a sealing device which secures sealability and improves durability.

In some embodiments of the present disclosure, a sealing device according to the present invention seals a space between a rotating shaft inserted into a container and the container. The sealing device includes a housing fixed to the container and positioned around the rotating shaft; a filler filled between the housing and the rotating shaft; a holding mechanism part fixed to the rotating shaft and positioned between the rotating shaft and the housing to hold the filler; and a regulation part positioned between a rotating shaft side and a housing side in the holding mechanism part and suppressing leakage of the filler. The holding mechanism part includes a storing chamber storing the filler in the housing side with respect to the rotating shaft, and a driving part fixed to the rotating shaft and projecting to the storing chamber and driven to flow the filler, and the filler seals the regulation part and has viscosity secured in the holding mechanism part.

Therefore, in the sealing device, the holding mechanism part is filled with and stores (secures) the filler between the housing and the rotating shaft, so that the space between the container and the rotating shaft is easily sealed by the filler and the sealability is easily enhanced. Further, the sealing device eliminates a friction portion by contacting the housing and the rotating shaft, so that the durability is easily enhanced.

In some embodiments of the present disclosure, in the sealing device, the housing includes, in a radial direction of the rotating shaft, an introducing passage introducing the filler to the holding mechanism part, and a discharging passage discharging the filler from the holding mechanism part.

In some embodiments of the present disclosure, in the sealing device, the storing chamber formed along the rotating shaft has an expansion part in which a distance from the rotating shaft is large on a side close to the container, and a narrow part in which a distance from the rotating shaft is small on a side apart from the container. The driving part includes a cylindrical part fixed to the rotating shaft, a restriction part, which has a diameter adjacent to the expansion part from the cylindrical part in the container side and suppressing flow of the filler to the container side, and a spiral projection part, which has a diameter adjacent to the narrow part from the cylindrical part and is formed in a spiral shape in a circumference of the cylindrical part from the narrow part to the restriction part. The spiral projection part makes the filler flow from the narrow part to the restriction part by synchronizing with a movement of the rotating shaft.

In some embodiments of the present disclosure, in the sealing device, the storing chamber includes a cylindrical storing chamber which is formed in a cylindrical shape and is separated from the rotating shaft, a first annular groove part which is formed in an annular shape recessed further outside than the cylindrical storing chamber in a radial direction at a side close to the container of the cylindrical storing chamber, and a second annular groove part, which is formed in an annular shape recessed further outside than the cylindrical storing chamber in the radial direction at an opposite side from the first annular groove part of the cylindrical storing chamber. The driving part includes a first disk part which is formed in a disk shape and is inserted into the first annular groove part fixed to the rotating shaft and has a diameter adjacent to the first annular groove part in the radial direction and suppresses the flow of the filler to the container side, a second disk part which is formed in a disk shape and is inserted into the second annular groove part fixed to the rotating shaft and has a diameter adjacent to the second annular groove part in the radial direction and suppresses the flow of the filler to the opposite side from the container, four eaves-shaped projection parts which are respectively positioned on both surfaces of the first disk part in a shaft direction and both surfaces of the second disk part in the shaft direction and are formed in a spiral shape toward an outside in the radial direction from the rotating shaft side around the rotating shaft, and a cylindrical spacer which fixes an interval between the first disk part and the second disk part. The four eaves-shaped projection parts make the filler flow in a direction from the first annular groove part and the second annular groove part to the cylindrical storing chamber by synchronizing the movement of the rotating shaft.

In some embodiments of the present disclosure, in the sealing device, the filler is polymer gel.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims. In the drawings, the size and relative sizes of layers and regions may be exaggerated for clarity. Like numbers refer to like elements throughout. The terminology used herein is for the purpose of describing particular embodiments only and is not intended to be limiting of the invention. As used herein, the singular forms “a”, “an” and “the” are intended to include the plural forms as well, unless the context clearly indicates otherwise. As used herein, the term “and/or” includes any and all combinations of one or more of the associated listed items and may be abbreviated as “/”. It will be understood that, although the terms first, second, etc. may be used herein to describe various elements, these elements should not be limited by these terms. Unless indicated otherwise, these terms are only used to distinguish one element from another. For example, a first object could be termed a second object, and, similarly, a second object could be termed a first object without departing from the teachings of the disclosure. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. It will be understood that when an element is referred to as being “connected” or “coupled” to or “on” another element, it can be directly connected or coupled to or on the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.). However, the term “contact,” as used herein refers to direct contact (i.e., touching) unless the context indicates otherwise. Terms such as “same,” “planar,” or “coplanar,” as used herein when referring to orientation, layout, location, shapes, sizes, amounts, or other measures do not necessarily mean an exactly identical orientation, layout, location, shape, size, amount, or other measure, but are intended to encompass nearly identical orientation, layout, location, shapes, sizes, amounts, or other measures within acceptable variations that may occur, for example, due to manufacturing processes. The term “substantially” may be used herein to reflect this meaning. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

### BRIEF DESCRIPTION OF THE DRAWINGS

FIG. 1 is a cross-sectional view showing a basic structure of a sealing mechanism of a sealing device according to embodiment 1 of the present invention.

FIG. 2 is a cross-sectional view showing a basic structure of a sealing mechanism of a sealing device according to embodiment 2 of the present invention.

### DETAILED DESCRIPTION

In the following paragraphs, some embodiments of the invention will be described by way of example and not limitation. It should be understood based on this disclosure that various other modifications can be made by those in the art based on these illustrated embodiments.

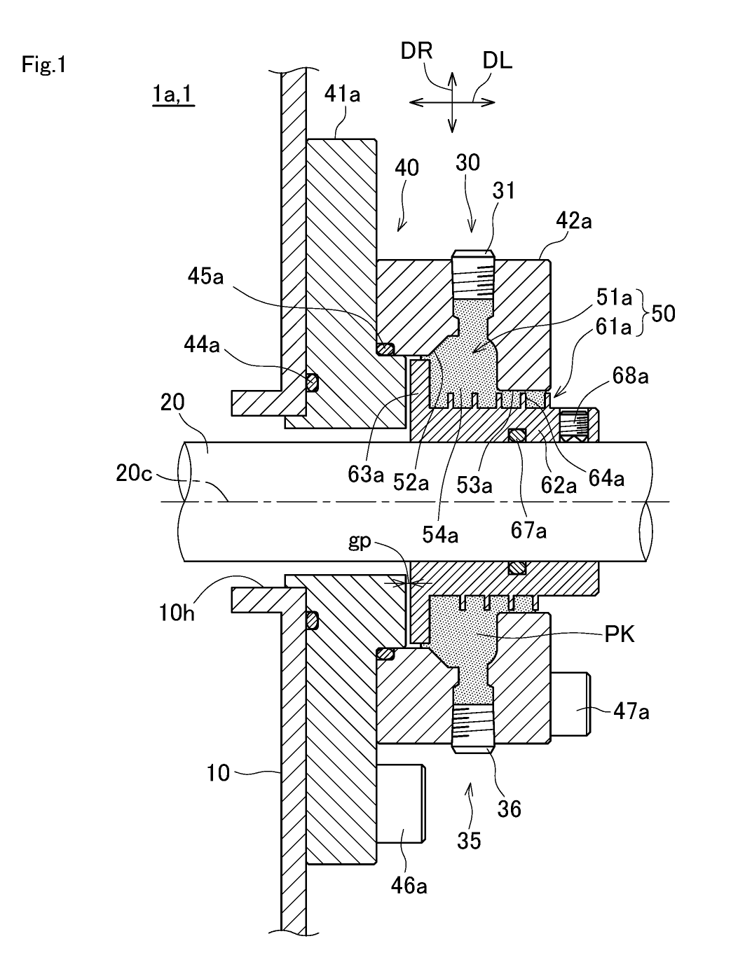

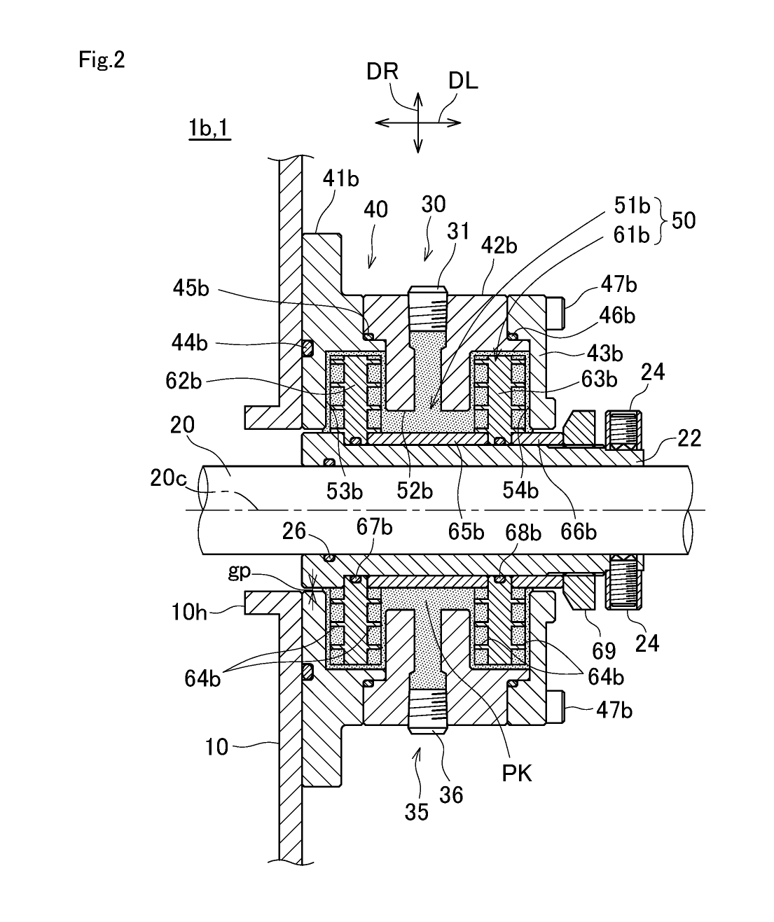

Hereinafter, the embodiments of the present invention will be described in reference to the drawings (FIGS. 1 and 2).

FIG. 1 shows a sealing device 1a according to embodiment 1 of the present invention. FIG. 2 shows a sealing device 1b according to embodiment 2 of the present invention. Hereinafter, if there is no particular difference between the sealing device 1a and the sealing device 1b, it is simply referred to as a sealing device 1.

FIGS. 1 and 2 are a cross-sectional view when cutting the sealing device 1 in a plane surface passing through a center 20c of a rotating shaft 20 (a shape of the rotating shaft 20 in a radial direction DR and a shaft direction DL). The radial direction DR means a direction along a radius of the rotating shaft 20, and the shaft direction DL means a direction along a length of the rotating shaft 20.

Further, the descriptions of a bearing part (not shown), etc. in order to control a rotary operation of the rotating shaft 20 will be omitted.

### Embodiment 1: FIG. 1

The sealing device 1a according to embodiment 1 of the present invention will be described in reference to FIG. 1.

FIG. 1 is a cross-sectional view showing a basic structure of a sealing mechanism of a sealing device 1a according to embodiment 1 of the present invention.

The sealing device 1a seals a space between the rotating shaft 20, which is inserted into a container 10, and the container 10. The sealing device 1a is provided with a housing 40, which is positioned around the rotating shaft 20 and fixed to the container 10, a filler PK, which is filled between the housing 40 and the rotating shaft 20, and a holding mechanism part 50, which is fixed to the rotating shaft 20 and holds the filler PK in a position between the rotating shaft and the housing 40. By the way, the rotating shaft 20 is inserted into the container 10 through a shaft hole 10h.

The filler PK will be described separately in embodiment 3.

In the sealing device 1a, the holding mechanism part 50 is held by filling the filler PK between the housing 40 and the rotating shaft 20, so that it is easily sealed by the filler PK between the container 10 and the rotating shaft 20. Therefore, the sealability is easily enhanced. Further, a friction portion made by contacting the housing 40 and the rotating shaft 20 is eliminated, so that the durability is easily enhanced.

The rotating shaft 20 employs a form performing, for example, a rotary operation with respect to the fixed container 10, and the housing 40, the holding mechanism part 50, and the filler PK are positioned annularly around the rotating shaft 20. The rotating shaft 20 is rotationally moved around, for example, a center 20c as a center.

In the sealing device 1a, the filler PK fills and is stored between the housing 40 and the rotating shaft 20, so that the sealability is secured and the durability is easily enhanced.

In a radial direction DR of the rotating shaft 20, the housing 40 in the sealing device 1a is provided with an introducing passage 30 which introduces the filler PK to the holding mechanism part 50, and a discharging passage 35 which discharges the filler PK from the holding mechanism part 50.

Since the sealing device 1a is provided with the introducing passage 30 and the discharging passage 35 of the filler PK, the replacement of the filler PK is easily performed. Therefore, in the sealing device 1a, the sealability easily maintains for a long time, and the durability is easily enhanced. Further, in a case in which the sealability of the filler PK is deteriorated, in the sealing device 1a, refilling or replacing the filler PK is easily performed, so that the accuracy of the reliability management for the operation is easily improved.

It is preferable to position the introducing passage 30 and the discharging passage 35 on sides opposite to each other in the radial direction DR (opposite side in diameter). Therefore, in the sealing device 1a, the replacement of the filler PK is easily and accurately performed.

The introducing passage 30 is provided with an introducing passage closing part 31 which closes the introducing passage 30 from the outside. The discharging passage 35 is provided with a discharging passage closing part 36 which closes the discharging passage 35 from the outside.

In the introducing passage 30 and the discharging passage 35, the introducing passage closing part 31 and the discharging passage closing part 36 surely shut off from the outside so as to store the filler PK in the space between the rotating shaft 20 and the housing 40. Therefore, in the sealing device 1a, the sealability by using the filler PK is easily realized with accuracy.

The introducing passage closing part 31 and the discharging passage closing part 36 are configured by, for example, a bolt, a screw member, etc., so that the filler PK is easily and surely sealed.

The holding mechanism part 50 is provided with a storing chamber 51a which stores the filler PK in the housing 40 side with respect to the rotating shaft 20, and a driving part 61a which is fixed to the rotating shaft 20, projects to the storing chamber 51a, and is driven to flow the filler PK. That is, the holding mechanism part 50 becomes a fixing state to the rotating shaft 20 through the driving part 61a.

In the sealing device 1a, the filler PK is stored in the storing chamber 51a, and the filler PK easily flows in response to the rotation of the rotating shaft 20 driven by the driving part 61a in which the stored filler PK is combined with the storing chamber 51a. That is, in the sealing device 1a, the filler PK fills and is stored between the housing 40 and the rotating shaft 20, so that the sealability between the housing 40 and the rotating shaft 20 is easily enhanced.

The sealing device 1a is provided with a housing member 41a and a housing member 42a as the housing 40. The housing member 41a is arranged in close contact through an O-ring 44a. The housing member 42a is arranged in close contact through an O-ring 45a.

The housing member 41a is fixed to the container 10 by a fixing tool 46a. The housing member 42a is fixed to the housing member 41a by a fixing tool 47a. That is, the housing 40 is configured with the housing member 41a and the housing member 42a.

The housing member 41a and the housing member 42a are arranged in close contact by the O-ring 44a, the O-ring 45a, the fixing tool 46a, and the fixing tool 47a, so as to maintain the close contact state each other. Therefore, it functions as the integrated housing 40.

Further, the housing 40 is configured with the combination of the housing member 41a and the housing member 42a, and the storing chamber 51a is formed between the housing 40 and the rotating shaft 20.

The storing chamber 51a includes an expansion part 52a which has a large distance from the rotating shaft 20 on the side close to the container 10, and a narrow part 53a which has a small distance from the rotating shaft 20 on the side apart from the container 10.

The driving part 61a is provided with a cylindrical part 62a fixed to the rotating shaft 20, a restriction part 63a having, in the container 10 side, a diameter adjacent to the expansion part 52a from the cylindrical part 62a and suppresses the flow of the filler PK in the container 10 side, and a spiral projection part 64a having a diameter adjacent to the narrow part 53a from the cylindrical part 62a and surrounding the circumference of the cylindrical part 62a in a spiral-shape from the narrow part 53a to the restriction part 63a.

The spiral projection part 64a makes the filler PK flow from the narrow part 53a to the restriction part 63a by synchronizing with the movement of the rotating shaft 20.

The expansion part 52a positioned in the container 10 side has the large distance from the cylindrical part 62a, so that the storing chamber 51a becomes large and a necessary amount of the filler PK is easily stored. The expansion part 52a (housing 40 side) and the restriction part 63a (rotating shaft 20 side) are arranged adjacent to each other in the radial direction DR, so that it becomes a state in which the filler PK is filling. Therefore, the sealability between the container 10 and the rotating shaft 20 is easily secured.

In the narrow part 53a positioned on the side apart from the container 10 while the expansion part 52a is disposed in between, the spiral projection part 64a positioned adjacent to the narrow part 53a makes the filler PK flow to the restriction part 63a side, so that it becomes a state in which the filler PK fills between the narrow part 53a (housing 40 side) and the spiral projection part 64a (rotating shaft 20 side). Therefore, the sealability between the container 10 (housing 40) and the rotating shaft 20 is easily secured.

The spiral projection part 64a makes the filler PK flow and supply from the narrow part 53a to the restriction part 63a, so that the filler PK flowing to the restriction part 63a circulates from the restriction part 63a to the narrow part 53a along the housing 40. Therefore, the sealability by the filler PK in the narrow part 53a is easily enhanced.

The end of the storing chamber 51a in the shaft direction DL has a regulation part gp which is made as small as possible between the rotating shaft 20 (and the cylindrical part 62 which is integrated with the rotating shaft 20) and the housing 40 (the housing member 41a, the housing member 42a) and regulates the flow of the filler PK. The regulation part gp will be described separately in embodiment 3.

With this structure, it becomes a state in which the filler PK fills between the housing 40 (the expansion part 52a and the narrow part 53a) and the rotating shaft 20 (the restriction part 63a and the spiral projection part 64a), so that the sealability between the housing 40 and the rotating shaft 20 is easily secured. Therefore, in the sealing device 1a, the sealability is easily secured.

The driving part 61a (cylindrical part 62a) is fixed to the rotating shaft 20 by a fixing tool 68a which is configured by a setscrew, etc. The cylindrical part 62a is connected to the rotating shaft 20 through an O-ring 67a, so that it becomes a form in close contact with the rotating shaft 20.

The restriction part 63a is projected in a disk-shaped from the cylindrical part 62a and is arranged adjacent to the expansion part 52a in the radial direction DR, so that it easily maintains a state in which the filler PK fills between the expansion part 52a and the restriction part 63a, and the sealability is easily secured.

The storing chamber 51a has an intermediate storing chamber 54a storing the filler PK between the expansion part 52a and the narrow part 53a, and the intermediate storing chamber 54a may be in a form to continue to the introducing passage 30 and the discharging passage 35.

In the intermediate storing chamber 54a positioned between the expansion part 52a and the narrow part 53a, the necessary amount of the filler PK is easily secured between the expansion part 52a and the narrow part 53a. That is, the intermediate storing chamber 54a secures liquidity of the filler PK. In the container 10 side, the sealability between the expansion part 52a and the restriction part 63a is easily secured. On the side apart from the container 10, the sealability between the narrow part 53a and the spiral projection part 64a is easily secured.

The intermediate storing chamber 54a may be in a form to continue to the introducing passage 30 and the discharging passage 35. The spiral projection part 64a may be positioned at the intermediate storing chamber 54a.

### Embodiment 2: FIG. 2

In reference to FIG. 2, a sealing device 1b according to embodiment 2 of the present invention will be described.

FIG. 2 is a cross-sectional view showing a basic structure of a sealing mechanism of a sealing device 1b according to embodiment 2 of the present invention.

In the sealing device 1b, for the parts which are the same parts as the sealing device 1a according to embodiment 1, the same reference numerals are applied and the description will be omitted accordingly.

The sealing device 1b seals between the rotating shaft 20 inserted into a container 10 and the container 10. The sealing device 1b is provided with a housing 40, which is positioned around the rotating shaft 20 and fixed to the container 10, a filler PK, which fills between the housing 40 and the rotating shaft 20, and a holding mechanism part 50 which is fixed to the rotating shaft 20 and holds the filler PK in a position between the rotating shaft and the housing 40. By the way, the rotating shaft 20 is inserted into the container 10 through a shaft hole 10h. The functions, etc. of the sealing device 1b are the same as the sealing device 1a, so that the detailed descriptions are omitted.

In the sealing device 1b, the holding mechanism part 50 is held by filling with the filler PK between the housing 40 and the rotating shaft 20, so that it is easily sealed by the filler PK between the container 10 and the rotating shaft 20. Therefore, the sealability is easily enhanced. Further, a friction portion by contacting the housing 40 and the rotating shaft 20 is eliminated, so that the durability is easily enhanced.

In a radial direction DR of the rotating shaft 20, the housing 40 of the sealing device 1b is provided with an introducing passage 30 which introduces the filler PK to the holding mechanism part 50, and a discharging passage 35 which discharges the filler PK from the holding mechanism part 50.

The holding mechanism part 50 is provided with a storing chamber 51b which stores the filler PK in the housing 40 side with respect to the rotating shaft 20, and a driving part 61b which is fixed to the rotating shaft 20, projects to the storing chamber 51b, and is driven to flow the filler PK. That is, the holding mechanism part 50 becomes a fixing state with the rotating shaft 20 through the driving part 61b.

In the sealing device 1b, the filler PK is stored in the storing chamber 51b, and the filler PK is easily flowing in response to the rotation of the rotating shaft 20 driven by the driving part 61b in which the stored filler PK is combined with the storing chamber 51b. That is, in the sealing device 1b, the filler PK fills and is stored between the housing 40 and the rotating shaft 20, so that the sealability between the housing 40 and the rotating shaft 20 is easily enhanced.

The sealing device 1b is provided with a housing member 41b, a housing member 42b, and a housing member 43b as the housing 40. The housing member 41b is arranged in close contact with the container 10 through an O-ring 44b. The housing member 42b is arranged in close contact with the housing member 41b through an O-ring 45b. The housing member 43b is arranged in close contact with the housing member 42b through an O-ring 46b.

The housing member 41b, the housing member 42b, and the housing member 43b are arranged in close contact with the container 10 by a fixing tool 47b. That is, the housing 40 is configured with the housing member 41b, the housing member 42b, and the housing member 43b.

The housing member 41b, the housing member 42b, and the housing member 43b are arranged in close contact with the container 10 by the O-ring 44b, the O-ring 45b, the O-ring 46b, and the fixing tool 47b, so as to maintain the close contact state each other. Therefore, it functions as the integrated housing 40.

Further, the housing 40 is configured with the combination of the housing member 41b, the housing member 42b and the housing member 43b, and the storing chamber 51b is formed between the housing 40 and the rotating shaft 20.

The storing chamber 51b is provided with a cylindrical storing chamber 52b, which is a cylindrical shape and is positioned apart from the rotating shaft 20, the first annular groove part 53b which is an annular shape and is recessed further outside than the cylindrical storing chamber 52b in the radial direction DR on the side close to the container 10 of the cylindrical storing chamber 52b, and the second annular groove part 54b which is an annular shape and is recessed further outside than the cylindrical storing chamber 52b in the radial direction DR in the position opposite from the first annular groove part 53b of the cylindrical storing chamber 52b.

The driving part 61b is provided with a disk-shaped first disk part 62b which is inserted into the first annular groove part 53b fixed to the rotating shaft 20, has a diameter adjacent to the first annular groove part 53b in the radial direction DR, and suppresses the flow of the filler PK to the container 10 side. Further, it is provided with a disk-shaped second disk part 63b which is inserted into the second annular groove part 54b fixed to the rotating shaft 20, has a diameter adjacent to the second annular groove part 54b in the radial direction DR, and suppresses the flow of the filler PK on the side opposite to the container 10. Furthermore, it is provided with four eaves-shaped projection parts 64b which are respectively positioned on both surfaces of the shaft direction DL of the first disk part 62b and on both surfaces of the shaft direction DL of the second disk part 63b, and which rotate around the rotating shaft 20 and are positioned in a spiral-shape toward outside in the radial direction DR from the rotating shaft 20 side. Still, it is provided with a cylindrical spacer 65b which maintains a space between the first disk part 62b and the second disk part 63b.

The four eaves-shaped projection parts 64b make the filler PK flow from the first annular groove part 53b and the second annular groove part 54b to the cylindrical storing chamber 52b by synchronizing with the movement of the rotating shaft 20.

In a space between the housing 40 and the rotating shaft 20, in the container 10 side, the first annular groove part 53b and the first disk part 62b are positioned adjacent to each other. In the position apart from the container 10, the second annular groove part 54b and the second disk part 63b are positioned adjacent to each other. The cylindrical storing chamber 52b positioned in the middle is filled with the filler PK which flows from the first annular groove part 53b and the second annular groove part 54b.

Therefore, in a space between the housing 40 (the first annular groove part 53b and the second annular groove part 54b) and the rotating shaft 20 (the first disk part 62b and the second disk part 63b), it becomes a state in which the filler PK fills, so that the sealability between the container 10 (housing 40) and the rotating shaft 20 is easily secured.

The end of the storing chamber 51b in the shaft direction DL has a regulation part gp which is made as small as possible between the rotating shaft 20 (shaft sleeve 22, cylindrical spacer 66b) and the housing 40 (the housing member 41b, the housing member 43b) and regulates the flow of the filler PK.

The four eaves-shaped projection parts 64b make the filler PK flow and supply from the first disk part 62b and the second disk part 63b to the first annular groove part 53b and the second annular groove part 54b, respectively. The filler PK filling in the first annular groove part 53b and the second annular groove part 54b is circulated from the first annular groove part 53b and the second annular groove part 54b to the cylindrical storing chamber 52b. Therefore, the sealability by the filler PK in the cylindrical storing chamber 52b is easily enhanced.

Therefore, the cylindrical storing chamber 52b positioned between the housing 40 and the rotating shaft 20 maintains the state in which the filler PK fills, so that the sealability between the housing 40 and the rotating shaft 20 is easily secured. Therefore, in the sealing device 1b, the sealability is easily secured.

The cylindrical storing chamber 52b is regulated in a shape of the side opposing to the rotating shaft 20 of the housing 40 (housing member 42b) facing the rotating shaft 20. The first annular groove part 53b and the second annular groove part 54b are regulated in a shape of the side opposing to the rotating shaft 20 of the housing 40 (housing member 41b, housing member 42b) facing the rotating shaft 20.

The first annular groove part 53b and the second annular groove part 54b are an approximately rectangular shape in a cross-section by a plane passing through the center 20c of the rotating shaft 20. In the first annular groove part 53b and the second annular groove part 54b, the filler PK flows to the outside of the radial direction DR from the side of the rotating shaft 20 by the function of the eaves-shaped projection parts 64b positioned in a spiral-shape on the surface of the first disk part 62b and the second disk part 63b faced each other. Therefore, the sealability between the rotating shaft 20 (the first disk part 62b, the second disk part 63b) and the housing 40 (the first annular groove part 53b, the second annular groove part 54b) is easily enhanced.

The first disk part 62b is aligned to and positioned at the end of the container 10 side of the shaft sleeve 22. The second disk part 63b is positioned by the cylindrical spacer 65b positioned between the first disk part 62b and the second disk part. The second disk part 63b is positioned by the cylindrical spacer 66b positioned in an opposite side of the cylindrical spacer 65b. The first disk part 62b, the cylindrical spacer 65b, the second disk part 63b, and the cylindrical spacer 66b are fixed by a fixing tool 69, for example, a nut configuration with respect to the shaft sleeve 22 in the outside of the housing 40.

The length of the cylindrical spacer 65b and the cylindrical spacer 66b is preliminary set in order to position the first disk part 62b and the second disk part 63b in a self-aligned manner with respect to the first annular groove part 53b and the second annular groove part 54b.

That is, positioning and fixing the first disk part 62b and the second disk part 63b are performed to the shaft sleeve 22 by the fixing tool 69.

The shaft sleeve 22 is fixed to the rotating shaft 20 by a sleeve fixing tool 24. That is, the first disk part 62 and the second disk part 63b fixed to the shaft sleeve 22 are fixed to the rotating shaft 20. The shaft sleeve 22 is connected to the rotating shaft 20 through the O-ring 26, so that it is arranged in close contact with the rotating shaft 20.

Further, the first disk part 62b is fixed to the shaft sleeve 22 through the O-ring 67b, and the second disk part 63b is fixed to the shaft sleeve 22 through the O-ring 68b. That is, the first disk part 62b and the second disk part 63b are arranged in close contact with the shaft sleeve 22 so as to be integrated with the rotating shaft 20 and make a form of the rotating shaft 20 side.

At the end of the first annular groove part 53b and the second annular groove part 54b, which are provided in the housing 40 (container 10), in the shaft direction DL, that is, the end of the storing chamber 51b, as described above, a regulation part gp is provided between the shaft sleeve 22 (rotating shaft 20, cylindrical spacer 66b) and the housing 40.

It is preferable that the cylindrical storing chamber 52b continues the introducing passage 30 and the discharging passage 35. The cylindrical storing chamber 52b continues to the introducing passage 30 and the discharging passage 35 so as to easily secure the necessary amount of the filler PK. That is, the cylindrical storing chamber 52b secures the liquidity of the filler PK, so that the sealability between the first annular groove part 53b and the first disk part 62b and the sealability between the second annular groove part 54b and the second disk part 63b are easily enhanced.

### Embodiment 3

Regarding the filler PK and the regulation part gp in embodiments 1 and 2, it will be further described as embodiment 3.

The required conditions of the filler PK in embodiments 1 and 2 are to secure the filling performance when the filler PK fills from outside and to secure the sealability after filling with the filler PK in the holding mechanism part 50 positioned between the rotating shaft 20 and the housing 40.

That is, in order to fill with the filler PK in the holding mechanism part 50, it requires the liquidity and the lubricity of the filler PK filling the holding mechanism part 50, and further, it requires the sealability to prevent the regulation part gp positioned between the rotating shaft 20 side and the housing (container 10) side in the shaft direction DL of the holding mechanism part 50 from leaking. The sealability of the filler PK is defined by, mainly, viscosity. Accordingly, the required viscosity of the filler PK is defined by the physical property value of which the space between the rotating shaft 20 and the housing 40 is sealed and secured by the holding mechanism part 50.

The preferable examples of the filler PK having liquidity, lubricity, and viscosity will be described as follows.

A polymer gel having an intermediate property between liquid and solid which has both liquid property and solid property is applied as the filler PK and obtains a good result for the sealability. The polymer gel has the property as solid, so that it does not have to consider the leaking in the regulation part gp, and the sufficient sealability is easily secured.

The dimension of the narrow part in the regulation part gp is, for example, 0.1 to 0.3 mm, so as to maintain the sealability by the polymer gel in the state of which it is prevented from sliding.

The regulation part gp is sealed by the filler PK which is totally different from the conventional sealing device having a sealing mechanism by a sliding structure, so that the sliding between the container 10 (housing 40) side and the rotating shaft 20 side is surely eliminated and the durability is enhanced.

The polymer gel as the filler PK has a liquid property, so that it can be well filling the holding mechanism part 50. It is preferable that the polymer gel is, for example, mineral oil purified from crude oil as base oil. In the polymer gel of the mineral oil, when the viscosity is, for example, 10,000 to 100,000 cP, it is capable of securing good sealability.

By the way, the diameter of the rotating shaft 20 of the sealing device 1 is, for example, 30 mm, and the rotational speed is, for example, 300 to 1200 times/minute. That is, the speed in the periphery of the rotating shaft 20 is approximately 0.5 to 2 m/second. With the polymer gel as the filler PK to the rotational movement, the sealability between the rotating shaft 20 and the housing 40 can be secured.

The filler PK is not limited to the aforementioned polymer gel, but it may be any materials which have the sealability of the sealing device 1 in embodiments 1 and 2.

The terms and descriptions used herein are used only for explanatory purposes and the present invention is not limited to them. Accordingly, the present invention allows various design-changes falling within the claimed scope of the present invention.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, the terminology “present invention” or “invention” is meant as a non-specific, general reference and may be used as a reference to one or more aspects within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features.

### Effect

The aforementioned sealing devices are filled with and stores the filler between the housing and the rotating shaft, so that it has effects in which securing sealability and enhancing durability are easily performed.

What is claimed is:

1. A sealing device, which seals a space between a rotating shaft inserted into a container and the container, comprising:
a housing fixed to the container and positioned around the rotating shaft;
a filler filled between the housing and the rotating shaft;
a holding mechanism part fixed to the rotating shaft and positioned between the rotating shaft and the housing to hold the filler; and
a regulation part positioned between a rotating shaft side and a housing side in the holding mechanism part and suppressing leakage of the filler,
wherein the holding mechanism part includes a storing chamber storing the filler in the housing side with respect to the rotating shaft, and a driving part fixed to the rotating shaft and projecting to the storing chamber and driven to flow the filler, and
the filler seals the regulation part and has viscosity secured in the holding mechanism part.

2. The sealing device according to claim 1, wherein the storing chamber formed along the rotating shaft has an expansion part in which a distance from the rotating shaft is large on a side close to the container, and a narrow part in which a distance from the rotating shaft is small on a side apart from the container,
the driving part includes a cylindrical part fixed to the rotating shaft, a restriction part, which has a diameter adjacent to the expansion part from the cylindrical part in the container side and suppressing flow of the filler to the container side, and a spiral projection part, which has a diameter adjacent to the narrow part from the cylindrical part and is formed in a spiral shape in a circumference of the cylindrical part from the narrow part to the restriction part, and
the spiral projection part makes the filler flow from the narrow part to the restriction part by synchronizing with a movement of the rotating shaft.

3. The sealing device according to claim 1, wherein the storing chamber includes a cylindrical storing chamber which is formed in a cylindrical shape and is separated from the rotating shaft, a first annular groove part which is formed in an annular shape recessed further outside than the cylindrical storing chamber in a radial direction at a side close to the container of the cylindrical storing chamber, and a second annular groove part, which is formed in an annular shape recessed further outside than the cylindrical storing chamber in the radial direction at an opposite side from the first annular groove part of the cylindrical storing chamber,
the driving part includes a first disk part which is formed in a disk shape and is inserted into the first annular groove part fixed to the rotating shaft and has a diameter adjacent to the first annular groove part in the radial direction and suppresses the flow of the filler to the container side, a second disk part which is formed in a disk shape and is inserted into the second annular groove part fixed to the rotating shaft and has a diameter adjacent to the second annular groove part in the radial direction and suppresses the flow of the filler to the opposite side from the container, four eaves-shaped projection parts which are respectively positioned on both surfaces of the first disk part in a shaft direction and both surfaces of the second disk part in the shaft direction and are formed in a spiral shape toward an outside in the radial direction from the rotating shaft side around the rotating shaft, and a cylindrical spacer which fixes an interval between the first disk part and the second disk part, and
the four eaves-shaped projection parts make the filler flow in a direction from the first annular groove part and the second annular groove part to the cylindrical storing chamber by synchronizing the movement of the rotating shaft.

4. The sealing device according to claim 1, wherein the filler is polymer gel.

5. The sealing device according to claim 4, wherein the housing includes, in the radial direction of the rotating shaft, an introducing passage introducing the filler to the holding mechanism part, and a discharging passage discharging the filler from the holding mechanism part.

6. The sealing device according to claim 2, wherein the filler is polymer gel.

7. The sealing device according to claim 3, wherein the filler is polymer gel.

8. The sealing device according to claim 6, wherein the housing includes, in a radial direction of the rotating shaft, an introducing passage introducing the filler to the holding mechanism part, and a discharging passage discharging the filler from the holding mechanism part.

9. The sealing device according to claim 7, wherein the housing includes, in the radial direction of the rotating shaft, an introducing passage introducing the filler to the holding mechanism part, and a discharging passage discharging the filler from the holding mechanism part.
